(19) United States
(12) Patent Application Publication
(10) Pub. No.: US 2004/0012200 A1
(43) Pub. Date: Jan. 22, 2004

(54) Lower pull tube adapter

(76) Inventor: Milton Skillman, Mount Vernon, TX (US)

Correspondence Address: Russell J. Egan, Suite 120, 908 Town & Country Blvd., Houston, TX, 77024-2221, US

(21) Appl. No.: 10/201,223

(22) Filed: Jul. 22, 2002

(51) Int. Cl. F16L 25/00

(52) U.S. Cl. 285/333

(57) ABSTRACT

A lower pull tube adapter has an enlarged body portion and an enlarged seal surface so that one size pull tube adapter may be used for a wide range of reciprocating downhole well pumps of different sizes and types.

### BACKGROUND OF THE INVENTION

1. The Field of the Invention

The present invention pertains to beam pumping wells and, more particularly, to beam pumping wells having pull tubes which attach to the plunger portion of a reciprocating downhole pump.

2. The Prior Art

The typical pull tube adapter used on reciprocating beam pumping wells includes box X threads and is made for connecting a pull tube to the plunger portion of a reciprocating downhole pump. There are two types of standard reciprocating downhole pumps which can use such pull tube adapters. The first is a hollow tube pump and the second is a traveling barrel pump.

The disclosed lower pull tube adapter is an improvement over prior art adapters in that it provides the ability to use a larger pull tube for any given pump size. The use of a larger pull tube is desirable for several reasons. First, strength is added to the pump since larger, heavier parts have greater durability and break less frequently. Secondly, larger pull tubes have less flexing thereby lowering the chance of both metal fatigue and wear of the pull tube. The larger pull tube adapter allows for additional fluid flow.

The present lower pull tube adapter may be used with a downstroke pump, that is a pump in which fluid is pumped out of the well only on the downstroke of the pump and no fluid is pumped on the upstroke of the pump. A description of such a pump can be found in my U.S. Pat. No. 6,368,084, the disclosure of which is incorporated herein by reference.

### SUMMARY OF THE INVENTION

The present lower pull tube adapter has an enlarged body portion and an enlarged seal surface so that one size pull tube adapter may be used for a wide range of reciprocating downhole well pumps of different sizes and types. When used on a downstroke pump, the present lower pull tube adapter enables using one size pull tube and one size pull tube guide may a wide range of pump sizes. When used with a standard hollow tube pump or traveling barrel pump, the present lower pull tube adapter allows for greater strength and rigidity with more fluid flow.

### BRIEF DESCRIPTION OF THE DRAWINGS

The present invention will now be described, by way of example, with reference to the accompanying drawings in which:

FIG. 1 is a longitudinal section through the subject invention;

FIG. 2 is a perspective view of the subject invention; and

FIG. 3 is a side elevation showing the subject invention exploded from a pull tube and collar.

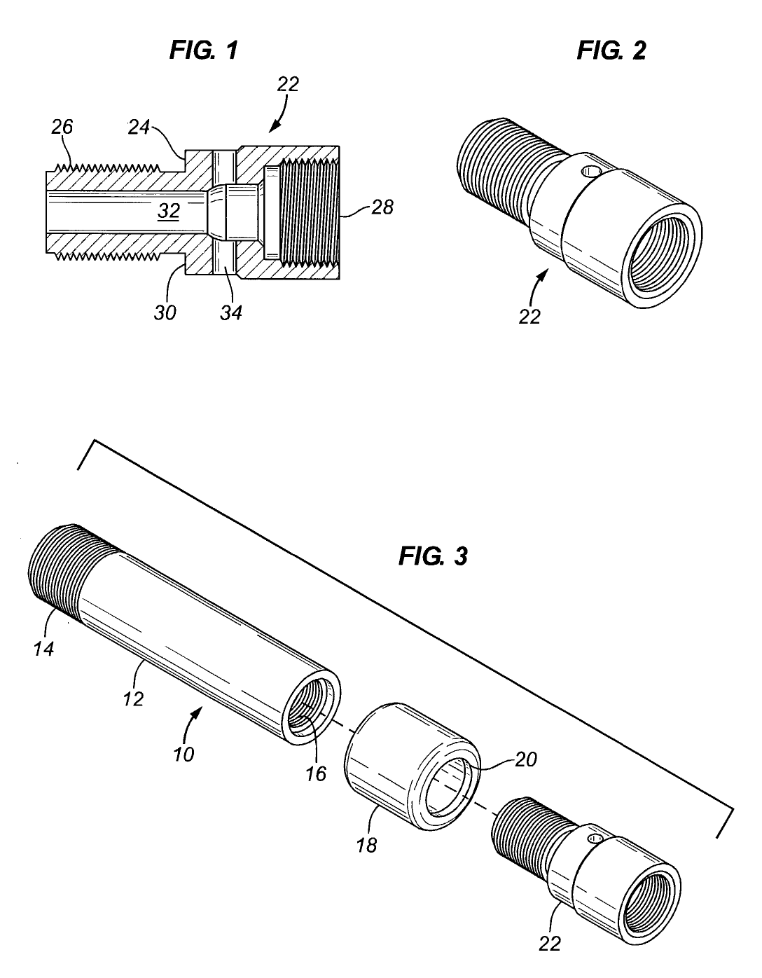

### DETAILED DESCRIPTION OF THE INVENTION

As shown in FIG. 3, the pull tube 10 has a hollow cylindrical body 12 which is externally threaded on an upper or first end 14 and internally threaded on a lower or second end 16. A cylindrical collar or guide 18, having an inwardly directed annular flange 20 on one end, is fitted over the lower end of the body 12.

The subject pull tube adapter 22 has a generally cylindrical body 24 with an externally threaded pin or first end 26 of a first diameter and an internally threaded second end 28 of a second larger diameter with an outwardly directed shoulder 30 between said ends. An axial bore 32 extends through the adapter and at least one radial bore 34 extends from the axial bore 32 to the surface of the adapter adjacent the shoulder 30 on the larger diameter portion of the adapter.

The first end 26 of the subject adapter engages the internally threaded lower or second end 16 of the pull tube 10. The shoulder 30 engages the flanged end 20 of the collar 18 to form a sealing interface between the subject adapter 22 and the pull tube 10. This threaded engagement of the internal threads 16 in the pull tube 10 with the external threads 26 of the pull tube adapter 22 provides a larger sealing surface and gives the user the option of using the collar or guide 18 to keep the pull tube 10 centered within the pump. Keeping the pull tube centered within the pump prevents wear of the adapter from metal-to-metal frictional contact.

The subject lower pull tube adapter also allows for the use of one size of a pull tube guide instead of the multiple sizes of pull tubes presently in use. As shown in the attached figures, a collar is held in place by the threadable attachment between the pull tube and the lower pull tube adapter. Typically, a pull tube for a 1¼ inch bore pump would be 15/16 inch in diameter. The lower pull tube adapter of the present invention will allow the use of a pull tube which is 1⅛ inches in diameter. This allows for greater strength and rigidity, and a larger seal surface with greater fluid flow.

The present invention may be subject to many modifications and changes without departing from the spirit of essential characteristics thereof. The present specification should therefor be considered in all respects as illustrative and not restrictive of the scope of the invention as defined by the appended claims.

I claim:

1. A lower pull tube adapter comprising:
an enlarged body portion; and
an enlarged seal surface whereby one size pull tube adapter may be used for a wide range of different sized reciprocating downhole well pumps.

2. A lower pull tube adapter comprising
a generally cylindrical body member having first and second attachment means on the opposite ends thereof, said first and second ends being of different diameters with an outwardly directed shoulder therebetween, an axial bore extending between said first and second ends, and at least one radial bore connecting said axial bore to the outer surface of said adapter on the larger diameter portion thereof.

3. In combination with a pull tube having a hollow cylindrical body externally threaded on an upper or first end and internally threaded on a lower or second end, a pull tube adapter having a generally cylindrical body with an externally threaded pin or first end of a first diameter, an internally threaded second end of a second larger diameter with an outwardly directed shoulder between said ends, an axial bore extending through the adapter and at least one radial bore connecting axial bore adjacent the shoulder on the larger diameter portion of the adapter.

4. The combination according to claim 3 further comprising:
cylindrical guide means received on said pull tube and having an inwardly directed annular flange in sealing contact between said pull tube and said shoulder of said adapter.
